(19) United States
(12) Patent Application Publication
(10) Pub. No.: US 2018/0247640 A1
(43) Pub. Date: Aug. 30, 2018

(54) METHOD AND APPARATUS FOR AN EXEMPLARY AUTOMATIC SPEECH RECOGNITION SYSTEM

(71) Applicant: Speech Morphing Systems, Inc., San Jose, CA (US)

(72) Inventors: Fathy Yassa, Soquel, CA (US); Meir Friedlander, Palo Alto, CA (US); Darko Pekar, Novi Sad (RS)

(73) Assignee: Speech Morphing Systems, Inc., San Jose, CA (US)

(21) Appl. No.: 15/963,844

(22) Filed: Apr. 26, 2018

Related U.S. Application Data
(63) Continuation-in-part of application No. 14/563,511, filed on Dec. 8, 2014.
(60) Provisional application No. 61/913,188, filed on Dec. 6, 2013.

(51) Int. Cl. G10L 15/06; G10L 15/16; G10L 13/04; G06N 3/04

(52) U.S. Cl. CPC G10L 15/063; G10L 15/16; G10L 2015/0638; G06N 3/0454; G10L 13/043

(57) ABSTRACT

An exemplary computer system configured to train an ASR using the output from a TTS engine.

### CROSS-REFERENCE TO RELATED APPLICATIONS

This patent application claims the benefit of U.S. Provisional Patent Application No. 62/527,247, filed on Jun. 30, 2017, and is a Continuation-in-Part of U.S. patent application Ser. No. 14/563,511, filed Dec. 8, 2014, which claims priority from U.S. Provisional Patent Application No. 61/913,188, filed on Dec. 6, 2013, in the U.S. Patent and Trademark Office, the disclosure of which is incorporated herein by reference in its entirety.

### BACKGROUND

### 1. Field

Embodiments herein relate to a method and apparatus for exemplary speech recognition.

### 2. Description of Related Art

Typically speech recognition is accomplished through the use of an Automatic Speech Recognition (ASR) engine, which operates by obtaining a small audio segment (“input speech”) and finding the closest matches in the audio database.

### SUMMARY

Embodiments of the present application relate to speech recognition using a specially optimized ASR that has been trained using a text to speech (“TTS”) engine and where the input speech is morphed so that it equates to the audio output of the TTS engine.

### BRIEF DESCRIPTION OF THE DRAWINGS

FIG. 1 illustrates a block diagram of a system for enhancing the accuracy of speech recognition according to an embodiment.

FIG. 2 illustrates a flowchart of a method of recognizing speech according to an embodiment.

FIG. 3 illustrates a block diagram of a speech morphing module according to an embodiment. FIG. 4 illustrates a flowchart of a method of morphing speech according to an embodiment.

### DETAILED DESCRIPTION OF THE EMBODIMENTS

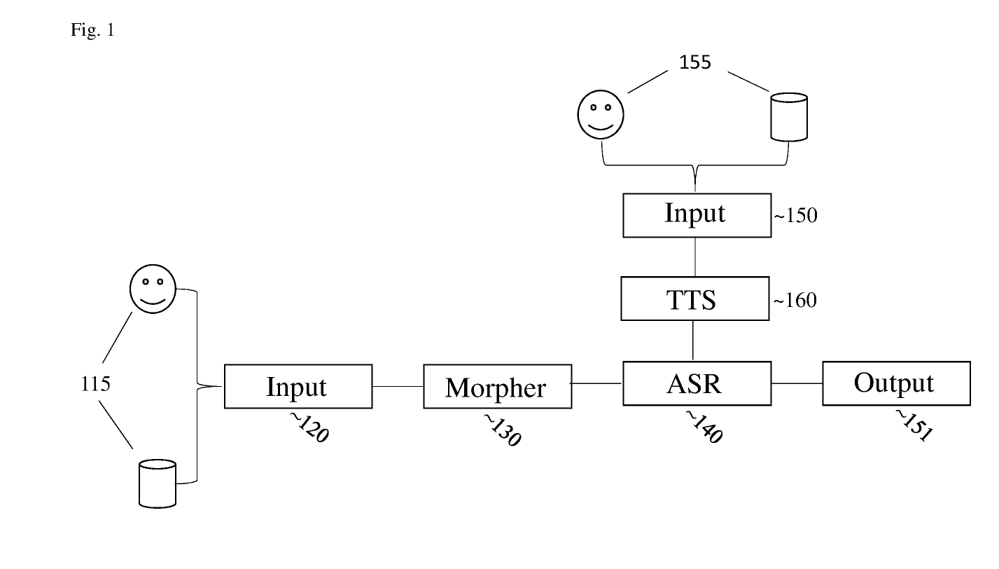

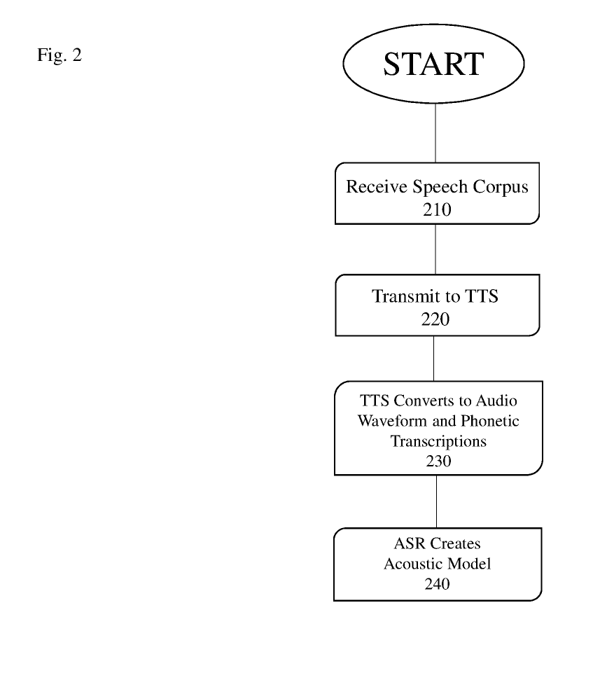

FIG. 1 illustrates a block diagram of a system for enhancing the accuracy of speech recognition according to an exemplary embodiment.

The speech recognition system in FIG. 1 may be implemented as a computer system 110; a computer comprising several modules, i.e. computer components embodied as either software modules, hardware modules, or a combination of software and hardware modules, whether separate or integrated, working together to form an exemplary computer system. The computer components may be implemented as a Field Programmable Gate Array (FPGA) or Application Specific Integrated Circuit (ASIC), which performs certain tasks. A unit or module may advantageously be configured to reside on the addressable storage medium and configured to execute on one or more processors or microprocessors. Thus, a unit or module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units may be combined into fewer components and units or modules or further separated into additional components and units or modules.

Input 120 is a module configured to receive human speech from an audio source 115, and output the input speech to Morpher 130. The audio source 115 may be a live person speaking into a microphone, recorded speech, synthesized speech, etc.

Morpher 130 is a module configured to receive human speech from Input 120, morph said input speech, and in particular the pitch, duration, and prosody of the speech units, into the same pitch, duration and prosody on which ASR 140 was trained, and route said morphed speech to an ASR 140. Module 130 may be software modules, hardware modules, or a combination of software and hardware modules, whether separate or integrated, working together to perform said function.

ASR 140 may be software modules, hardware modules, or a combination of software and hardware modules, whether separate or integrated, working together to perform automatic speech recognition. ASR 140 is configured to receive the morphed input speech, decode the speech into the best estimate of the phrase by first converting the morphed input speech signal into a sequence of vectors which are measured throughout the duration of the speech signal. Then, using a syntactic decoder it generates one or more valid sequences of representations, assigns a confidence score to each potential representation, selects the potential representation with the highest confidence score, and outputs said representation as well as the confidence score for said selected representation.

To optimize ASR 140, ASR 140 uses “speaker-dependent speech recognition” where an individual speaker reads sections of text into the SR system, i.e. trains the ASR on a speech corpus. These systems analyze the person's specific voice and use it to fine-tune the recognition of that person's speech, resulting in more accurate transcription.

Output 151 is a module configured to output the text generated by ASR 140.

Input 150 is a module configured to receive text in the form of phonetic transcripts and prosody information from Text Source 155, and transmit said text to TTS 160. The Text Source 155 is a speech corpus, i.e. a database of speech audio files and phonetic transcriptions, which may be any of a plurality of inputs such as a file on a local mass storage device, a file on a remote mass storage device, a stream from a local area or wide area, a live speaker, etc.

Computer System 110 utilizes TTS 160 to train ASR 140 to optimize its speech recognition. TTS 160 is a text-to-speech engine configured to receive a speech corpus and synthesize human speech. TTS 160 may be software modules, hardware modules, or a combination of software and hardware modules, whether separate or integrated, working together to perform automatic speech recognition. TTS 160 is composed of two parts: a front-end and a back-end. The front-end has two major tasks. First, it converts raw text containing symbols like numbers and abbreviations into the equivalent of written-out words. This process is often called text normalization, pre-processing, or tokenization. The front-end then assigns phonetic transcriptions to each word, and divides and marks the text into prosodic units, like phrases, clauses, and sentences. The process of assigning phonetic transcriptions to words is called text-to-phoneme or grapheme-to-phoneme conversion. Phonetic transcriptions and prosody information together make up the symbolic linguistic representation that is output by the front-end. The back-end—often referred to as the synthesizer—then converts the symbolic linguistic representation into sound. In certain systems, this part includes the computation of the target prosody (pitch contour, phoneme durations) which is then imposed on the output speech.

FIG. 2 illustrates a flow diagram of how Computer System 110 trains ASR 140 to optimally recognize input speech. At step 210 Input 150 receives a speech corpus from Text Source 155 and transmits said speech corpus to TTS 160 at step 220. At step 230 TTS 160 converts said speech corpus into an audio waveform and transmits said audio waveform and the phonetic transcripts to ASR 140. ASR 140 receives the audio waveform and phonetic transcriptions from TTS 160 and creates an acoustic model by taking the audio waveforms of speech and their transcriptions (taken from a speech corpus), and ‘compiling’ them into a statistical representations of the sounds that make up each word (through a process called ‘training’). A unit of sound may be a either a phoneme, a diphone, or a triphone. This acoustic model is used by ASR 140 to recognize input speech.

Thus, ASR 140′s acoustic model is a near perfect match for TTS 160.

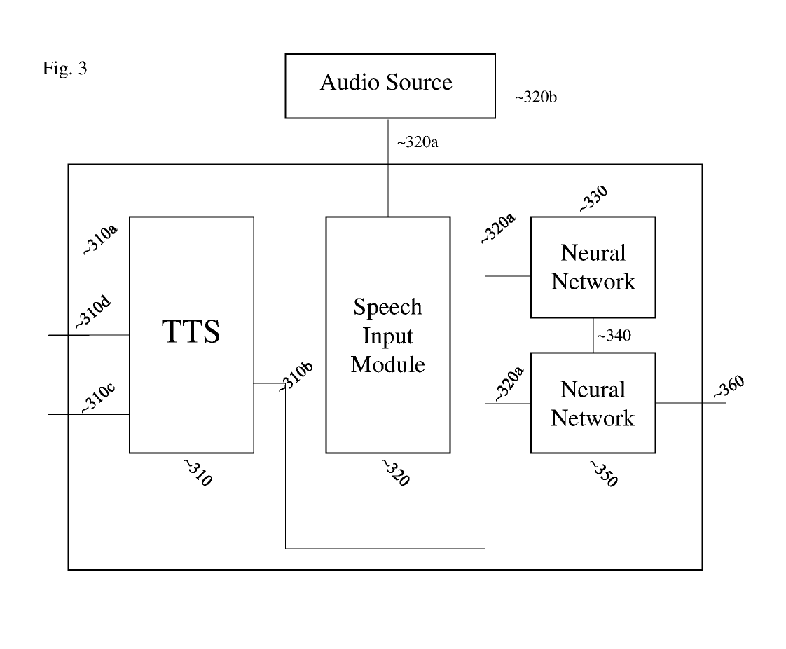

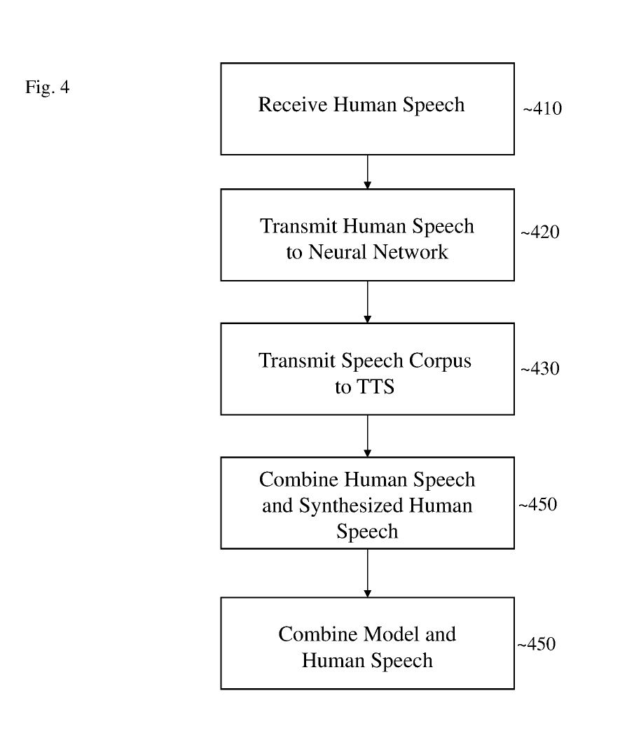

FIG. 3 illustrates a block diagram of Morpher 130 according to an exemplary embodiment. TTS 310 is a text to speech module engine configured to receive a speech corpus 310a comprising prosody information at of least one speech audio file of a first speaker, the reference voice 310d, and phonetic transcripts corresponding to at least one speech audio file 310c and synthesize human speech 310b. TTS 310 may be software modules, hardware modules, or a combination of software and hardware modules, whether separate or integrated, working together to perform automatic speech recognition. TTS 310 is composed of two parts: a front-end and a back-end. The front-end has two major tasks. First, it converts raw text containing symbols like numbers and abbreviations into the equivalent of written-out words. This process is often called text normalization, pre-processing, or tokenization. The front-end then assigns phonetic transcriptions to each word, and divides and marks the text into prosodic units, like phrases, clauses, and sentences. The process of assigning phonetic transcriptions to words is called text-to-phoneme or grapheme-to-phoneme conversion. Phonetic transcriptions and prosody information together make up the symbolic linguistic representation that is output by the front-end. The back-end—often referred to as the synthesizer—then converts the symbolic linguistic representation into sound. In certain systems, this part includes the computation of the target prosody (pitch contour, phoneme durations) which is then imposed on the output speech. TTS 310 is further configured to output human speech 310b to neural network (NN) 330.

Speech Input module 320 is a module configured to receive human speech 320a from an audio source 320b and output the human speech 320a to NN 330. The human speech 320a may be a live person speaking into a microphone, recorded speech, synthesize speech, etc.

NN 330 is a neural network module configured to receive the human speech 320a from Speech Input 320 and human speech 310b and create a mathematical model, Model 340.

NN 350 is a neural network module configured to receive the human speech 320a from Speech Input 320 and human speech 310b. NN 350 is further configured to receive Model 340 and output the human speech 360. NN 350 is further configured to perform the inverse transformation to NN 330.

FIG. 4 illustrates a method of morphing speech. Morpher 130 receives human speech from Input 120, morphs said input speech, and in particular the pitch, duration, and prosody of the speech units, into the same pitch, duration and prosody on which ASR 140 was trained, and routes said morphed speech to an ASR 140.

At step 410, speech input module 120 obtain human speech from audio source 115. At Step 420, audio source 115 transmits the human speech to NN 330. The human speech 115 corresponds to speech corpus 310a, i.e. a text transcription. At step 430, speech corpus 310a is transmitted to TTS 310, wherein TTS 310 synthesizes human speech 310b to NN 330 corresponding to speech corpus 310a.

At step 440, NN330 combines the human speech and the synthesized human speech 310b and creates a mathematical model of the combination, Model 340.

Steps 410 to 440, inclusive generally do not occur in real time.

At Step 450, speech input module 120 obtains human speech 320a from audio source 115. Said human speech is transmitted to NN 350. NN 350 also received Model 340, combines Model 340 and human speech human speech 320a and outputs human speech 360, which is identical to the TTS 160 or the reference voice.

We claim:

1. An automatic speech recognition (ASR) system comprising:
a first speech input module configured to receive a speech corpus comprising first prosody information of at least one speech audio file of a first speaker and first phonetic transcriptions corresponding to the at least one speech audio file;
a first text-to-speech (TTS) engine configured to receive the first prosody information and the first phonetic transcriptions from the first speech input module, synthesize at least one speech audio file of the first speaker into a first audio waveform having a first prosody based on the first prosody information, and output the first audio waveform;
a speech morphing module configured to morph human speech of a second speaker having a second prosody into morphed human speech of the first speaker having a prosody that is the same as first prosody of the first audio waveform of the at least one speech audio file of the first speaker output by the first TTS engine, the speech morphing module comprising:
a second TTS engine configured to receive a speech corpus comprising second prosody information of at least one speech audio file of the human speech of the second speaker and second phonetic transcriptions corresponding to at least one speech audio file of the human speech of the second speaker, and output a second audio waveform of speech of the second speaker having a second prosody based on the second prosody information;
a first neural network configured to receive the first audio waveform and the second audio waveform, and create a mathematical model of the first audio waveform and the second audio waveform; and
a second neural network configured to receive the mathematical model and the second audio waveform, and output the morphed human speech; and
an ASR engine comprising an acoustic model, the ASR engine configured to convert speech into text,
wherein the ASR engine is configured to receive the first audio waveform and the phonetic transcriptions output by the first TTS engine, receive the morphed human speech morphed by the speech morphing module, create the acoustic model through training on the first audio waveform and the first phonetic transcriptions output by the first TTS engine by compiling the first audio waveform and the first phonetic transcriptions output by the first TTS engine into statistical representations of words of the audio waveform based on the phonetic transcriptions, recognize the morphed human speech based on the trained acoustic model, and output text corresponding to the recognized morphed human speech.
